(19) United States
(12) Patent Application Publication
(10) Pub. No.: US 2006/0002017 A1
(43) Pub. Date: Jan. 5, 2006

(54) Perpendicular magnetic recording apparatus having discrete track media

(75) Inventors: Tomoko Taguchi, Kunitachi-shi (JP); Tsutomu Tanaka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/169,299

(22) Filed: Jun. 29, 2005

(30) Foreign Application Priority Data
Jun. 30, 2004 (JP) 2004-194311

(51) Int. Cl. G11B 5/127

(52) U.S. Cl. 360/125

(57) ABSTRACT

A perpendicular magnetic recording apparatus has a discrete track media including a substrate and a soft magnetic layer and a perpendicular recording layer formed on the substrate, the perpendicular recording layer including guard bands magnetically separating recording tracks from one another on the surface thereof, and a magnetic head including a main pole, an auxiliary yoke, and a coil. The main pole is adapted to have a shape on the air bearing surface satisfying a condition that a length of a line segment which is formed by projecting a side of the main pole along a head traveling direction onto a straight line perpendicular to the head traveling direction is smaller than a width of each of the guard bands in the discrete track media even when the main pole is positioned on any recording track of the discrete track media.

### CROSS-REFERENCE TO RELATED APPLICATIONS

This application is based upon and claims the benefit of priority from prior Japanese Patent Application No. 2004-194311, filed Jun. 30, 2004, the entire contents of which are incorporated herein by reference.

### BACKGROUND OF THE INVENTION

1. Field of the Invention

The present invention relates to a perpendicular magnetic recording apparatus having a discrete track media.

2. Description of the Related Art

A discrete track media has a structure in which adjacent recording tracks are magnetically separated from one another using a groove or a nonmagnetic material. The groove or nonmagnetic material magnetically separating the adjacent recording tracks will be referred to as guard bands below. The discrete track media is intended to prevent the magnetic field of the magnetic head from spreading to adjacent recording tracks. A very high recording density is expected to be achieved by applying such a discrete track media to a perpendicular magnetic recording media.

There has been proposed, in a perpendicular magnetic recording apparatus in which a perpendicular magnetic recording media that is not a discrete track media is incorporated, to use a main pole having a pole length larger than a track width on the air bearing surface (U.S. Pat. No. 6,639,754). Since this perpendicular magnetic recording apparatus does not take the skew angle of the magnetic head into account, however, the sides of the main pole on the air bearing surface may overlap the adjacent recording tracks, resulting in lowering a signal-to-noise ratio (SNR).

Also, there has been proposed, in another perpendicular magnetic recording apparatus in which a perpendicular magnetic recording media that is not a discrete track media is incorporated, to define the dimensions of the main pole taking the skew angle of the magnetic head into account (U.S. Pat. No. 5,995,341).

However, in connection with perpendicular magnetic recording apparatuses in which a discrete track media is incorporated, there is no proposal to suppress degradation in SNR by using an appropriate main pole taking the skew angle of the write head into account.

### BRIEF SUMMARY OF THE INVENTION

A perpendicular magnetic recording apparatus according to an aspect of the present invention comprises: a discrete track media comprising a substrate and a soft magnetic layer and a perpendicular recording layer formed on the substrate, the perpendicular.recording layer including guard bands formed of a groove or a nonmagnetic material magnetically separating recording tracks from one another on the surface thereof; and a magnetic head comprising a main pole, an auxiliary yoke, and a coil, wherein the main pole is adapted to have a shape on the air bearing surface satisfying a condition that a length of a line segment which is formed by projecting a side of the main pole along a head traveling direction onto a straight line perpendicular to the head traveling direction is smaller than a width of each of the guard bands in the discrete track media even when the main pole is positioned on any recording track of. the discrete track media.

### BRIEF DESCRIPTION OF THE SEVERAL VIEWS OF THE DRAWING

FIG. 1 is a perspective view showing a perpendicular magnetic recording apparatus according to embodiments of the present invention;

FIG. 2 is a plan view showing the shape of the main pole on the air bearing surface positioned on the discrete track media incorporated in the perpendicular magnetic recording apparatus according to a first embodiment of the present invention;

FIG. 3 is a plan view showing the shape of the main pole on the air bearing surface positioned on the discrete track media incorporated in the perpendicular magnetic recording apparatus according to a second embodiment of the present invention;

FIG. 4 is a plan view showing the shape of the main pole on the air bearing surface positioned on the discrete track media incorporated in the perpendicular magnetic recording apparatus according to a third embodiment of the present invention;

FIG. 5 is a plan view showing the shape of the main pole on the air bearing surface positioned on the discrete track media incorporated in the perpendicular magnetic recording apparatus according to a fourth embodiment of the present invention;

FIG. 6 is a plan view showing the shape of the main pole on the air bearing surface positioned on the discrete track media incorporated in the perpendicular magnetic recording apparatus according to a fifth embodiment of the present invention; and

FIG. 7 is a plan view of a discrete track media incorporated in a perpendicular magnetic recording apparatus according to another embodiment of the present invention.

### DETAILED DESCRIPTION OF THE INVENTION

Embodiments of the present invention will be described below with reference to the drawings.

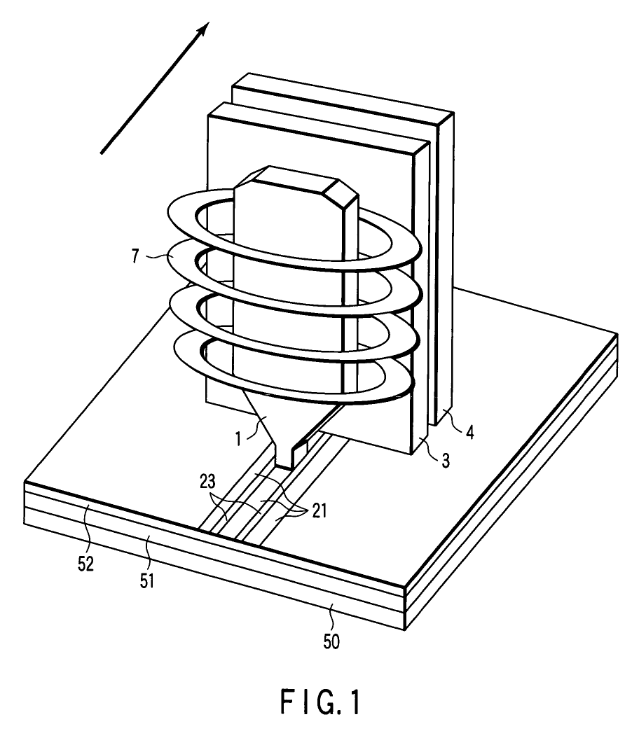

FIG. 1 is a perspective view showing a perpendicular magnetic recording apparatus according to embodiments of the present invention. In FIG. 1, the magnetic disk has, on the substrate 50, the soft magnetic layer 51 and the perpendicular recording layer 52 with magnetic anisotropy in a direction perpendicular to the film surface. Recording tracks 21 and guard bands 23 are formed in the film surface of the perpendicular recording layer 52. The guard bands 23 each consisting of a groove or a nonmagnetic material magnetically separate the adjacent recording tracks 21. Such a magnetic disk is referred to as a discrete track media.

The magnetic head includes a write head and a read head. The write head includes the main pole 1 of a high-permeability material that generates a magnetic field in the direction perpendicular to the disk surface, the return yoke 3 arranged on the leading side to the main pole 1 to efficiently form a closed magnetic circuit via the soft magnetic layer 51 immediately under the main pole, and the coil 7 wound around the magnetic circuit including the main pole 1 and the return yoke 3 so as to pass a magnetic flux through the main pole 1. The read head includes a magnetoresistive element (not shown in FIG. 1) and shield films 3 and 4 arranged on the trailing and leading sides to the magnetoresistive element. The shield film 3 on the trailing side also serves as the return yoke.

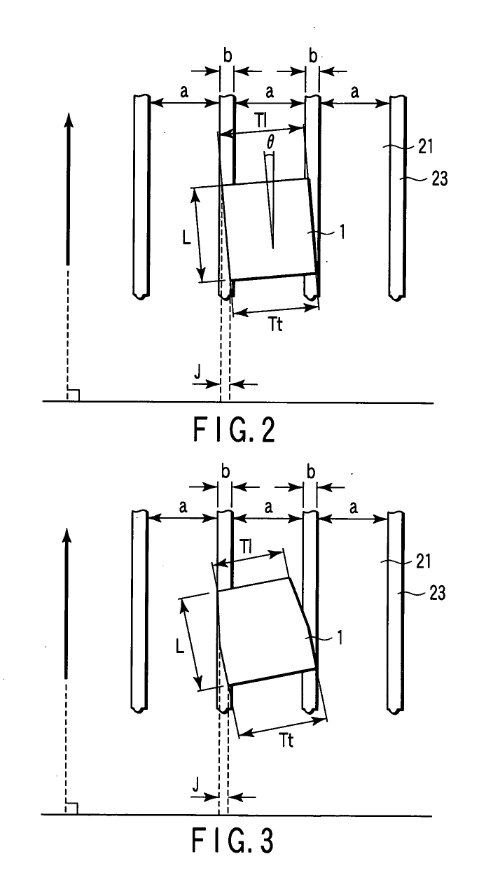

FIG. 2 is a plan view showing the shape of the main pole 1 on the air bearing surface (referred to as ABS hereinafter) positioned on the discrete track media incorporated in the perpendicular magnetic recording apparatus according to a first embodiment of the present invention. As shown in FIG. 2, the width of each of the recording tracks 21 in the discrete track media is defined as a, and the width of each of the guard bands magnetically separating the adjacent recording tracks 21 is defined as b. FIG. 2 shows that the magnetic head or the main pole 1 is inclined at an angle θ (referred to as a skew angle hereinafter) from the head traveling direction. In FIG. 2, the main pole 1 has a shape on ABS of substantially rectangle. In connection with the shape on ABS of the main pole 1, the length of each side along the head traveling direction, i.e., the length between the trailing edge and the leading edge along the head traveling direction is defined as L, the track width at the trailing edge is defined as Tₜ, and the track width at the leading edge is defined as Tₗ. The head traveling direction means the longitudinal direction of the tracks, which is opposite to the direction in which the media moves relative to the head.

In this case, as shown in FIG. 2, the length J (in FIG. 2, J=Lsin θ) of a line segment which is formed by projecting a side (having the length of L) of the main pole along the head traveling direction onto a straight line perpendicular to the head traveling direction is smaller than the width b of each of the guard bands 23 in the discrete track media. This condition is satisfied even when the main pole 1 is positioned on any recording track 21 of the discrete track media. This condition prevents the side of the main pole 1 from overlapping the adjacent recording track 21, making it possible to prevent degradation in SNR.

Further, in connection with the shape on ABS of the main pole 1, shown in FIG. 2, the length L between the trailing edge and leading edge of the main pole along the head traveling direction (in FIG. 2, the length of the side along the head traveling direction) is larger than the track width Tₜ at the trailing edge. This condition makes it possible to sufficiently increase the area of ABS of the main pole 1 to ensure sufficient field intensity even if the track width is reduced to increase track density, which enables improvement in recording resolution.

FIG. 3 is a plan view showing the shape of the main pole 1 on ABS positioned on the discrete track media incorporated in the perpendicular magnetic recording apparatus according to a second embodiment of the present invention. The meanings of the symbols used for the discrete track media and main pole 1 are similar to those of the symbols in FIG. 2. FIG. 3 also shows that the main pole 1 is inclined at a certain skew angle to the head traveling direction. In FIG. 3, the main pole 1 has a shape on ABS of a hexagon with projections on both sides along the head traveling direction. As a result, the track width Tₜ at the trailing edge is larger than the track width Tₗ at the leading edge. The main pole 1 may have such a shape on ABS that a plurality of projections is provided on both sides along the head traveling direction.

Also in FIG. 3, the length J of a line segment which is formed by projecting a side of the main pole along the head traveling direction onto a straight line perpendicular to the head traveling direction is smaller than the width b of each of the guard bands 23 in the discrete track media. This condition is satisfied even when the main pole 1 is positioned on any recording track 21 of the discrete track media. This condition prevents the side of the main pole 1 from overlapping the adjacent recording track 21, making it possible to prevent degradation in SNR. Further, also in FIG. 3, the length L between the trailing edge and leading edge of the main pole along the head traveling direction is larger than the track width Tₜ at the trailing edge. This condition makes it possible to sufficiently increase the area of ABS of the main pole 1 to ensure sufficient field intensity even if the track width is reduced to increase track density, which enables improvement in recording resolution.

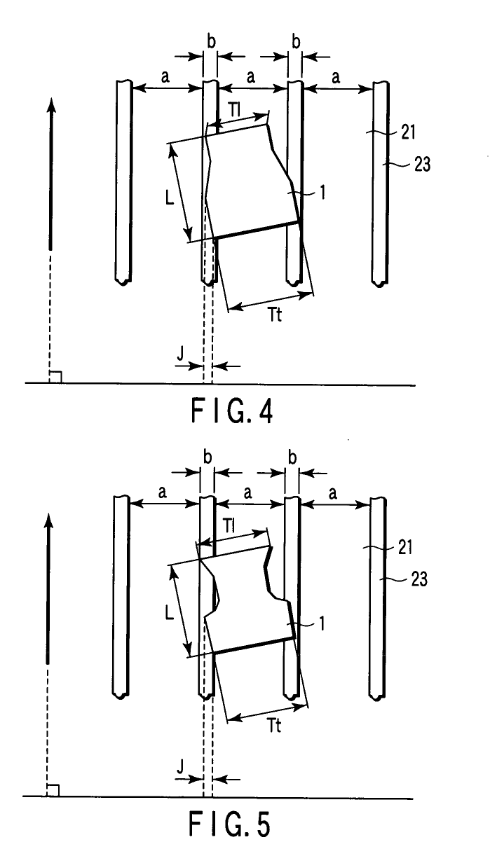

FIG. 4 is a plan view showing the shape of the main pole 1 on ABS positioned on the discrete track media incorporated in the perpendicular magnetic recording apparatus according to a third embodiment of the present invention. The meanings of the symbols used for the discrete track media and main pole 1 are similar to those of the symbols in FIG. 2. FIG. 4 also shows that the main pole 1 is inclined at a certain skew angle to the head traveling direction. In FIG. 4, the main pole 1 has a shape on ABS of an octagon with projections and recesses on both sides along the head traveling direction. As a result, the track width Tₜ at the trailing edge is larger than the track width Tₗ at the leading edge. The main pole 1 may have such a shape on ABS that a plurality of projections or recesses is provided on both sides along the head traveling direction.

Also in FIG. 4, the length J of a line segment which is formed by projecting a side of the main pole along the head traveling direction onto a straight line perpendicular to the head traveling direction is smaller than the width b of each of the guard bands 23 in the discrete track media. This condition is satisfied even when the main pole 1 is positioned on any recording track 21 of the discrete track media. This condition prevents the side of the main pole 1 from overlapping the adjacent recording track 21, making it possible to prevent degradation in SNR. Further, also in FIG. 4, the length L between the trailing edge and leading edge of the main pole along the head traveling direction is larger than the track width Tt at the trailing edge. This condition makes it possible to sufficiently increase the area of ABS of the main pole 1 to ensure sufficient field intensity even if the track width is reduced to increase track density, which enables improvement in recording resolution.

FIG. 5 is a plan view showing the shape of the main pole 1 on ABS positioned on the discrete track media incorporated in the perpendicular magnetic recording apparatus according to a fourth embodiment of the present invention. The meanings of the symbols used for the discrete track media and main pole 1 are similar to those of the symbols in FIG. 2. FIG. 5 also shows that the main pole 1 is inclined at a certain skew angle to the head traveling direction. In FIG. 5, the main pole 1 has a shape on ABS that curves forming recesses are formed on both sides along the head traveling direction. As a result, the track width Tₜ at the trailing edge is larger than the track width Tₗ at the leading edge.

Also in FIG. 5, the length J of a line segment which is formed by projecting a side of the main pole along the head traveling direction onto a straight line perpendicular to the head traveling direction is smaller than the width b of each of the guard bands 23 in the discrete track media. This condition is satisfied even when the main pole 1 is positioned on any recording track 21 of the discrete track media. This condition prevents the side of the main pole 1 from overlapping the adjacent recording track 21, making it possible to prevent degradation in SNR. Further, also in FIG. 5, the length L between the trailing edge and leading edge of the main pole along the head traveling direction is larger than the track width Tt at the trailing edge. This condition makes it possible to sufficiently increase the area of ABS of the main pole 1 to ensure sufficient field intensity even if the track width is reduced to increase track density, which enables improvement in recording resolution.

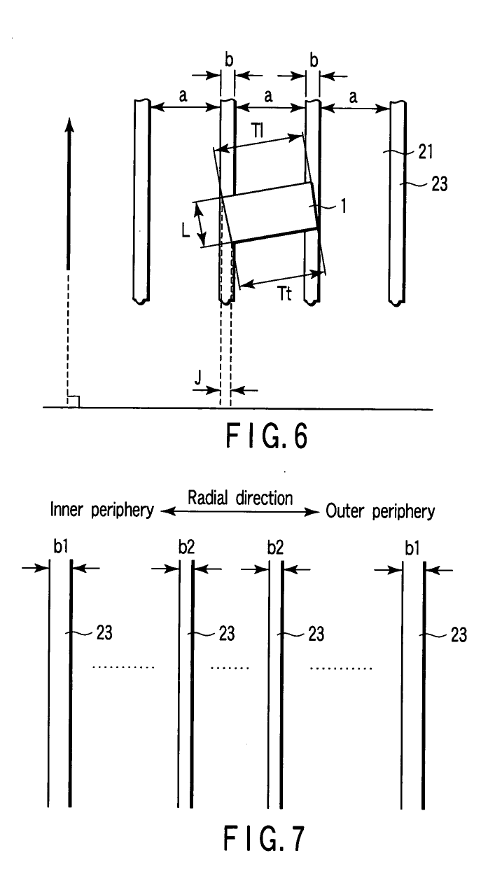

FIG. 6 is a plan view showing the shape of the main pole 1 on ABS positioned on the discrete track media incorporated in the perpendicular magnetic recording apparatus according to a fourth embodiment of the present invention. The meanings of the symbols used for the discrete track media and main pole 1 are similar to those of the symbols in FIG. 2. FIG. 6 also shows that the main pole 1 is inclined at a certain skew angle to the head traveling direction. In FIG. 6, the main pole 1 has a shape on ABS of a trapezoid in which the track width Tₗ at the leading edge is larger than the track width Tₜ at the trailing edge. Further, L of the main pole 1 shown in FIG. 6 is smaller than that of the main poles shown in FIGS. 2 to 5. In these points, the shape of the main pole in FIG. 6 is different from those of the main poles shown in FIGS. 2 to 5. The cross section of the main pole 1 on ABS in FIG. 6 is larger than the area of (the length L between the trailing edge and leading edge of the main pole 1)×(the track width Tₜ at the trailing edge). This makes possible to sufficiently increase the area of ABS of the main pole 1 to ensure sufficient field intensity, which enables improvement in recording resolution.

Also in FIG. 6, the length J of a line segment which is formed by projecting a side of the main pole along the head traveling direction onto a straight line perpendicular to the head traveling direction is smaller than the width b of each of the guard bands 23 in the discrete track media. This condition is satisfied even when the main pole 1 is positioned on any recording track 21 of the discrete track media. This condition prevents the side of the main pole 1 from overlapping the adjacent recording track 21, making it possible to prevent degradation in SNR.

The main poles shaped as shown in FIGS. 2 to 6 can be processed into a desired shape by adjusting, for example, the incident angle of an etching gas during sputter etching after a high-permeability material forming a main pole has been deposited.

In a discrete track media incorporated in a perpendicular magnetic recording apparatus according to another embodiment of the present invention, the width of the guard band may vary depending on a position in a radial direction of the discrete track media. For example, as shown in FIG. 7, it is possible to increase the width b1 of the guard band in inner and outer peripheral portions of the discrete track media where the skew angle of the main pole becomes larger, and to reduce the width b2 of the guard band in an intermediate portion along the radial direction of the discrete track media where the skew angle of the main pole is smaller.

The use of such a discrete track media makes it possible to increase a design margin for the main pole that relates to the overlapping of the sides of the main pole 1 to the adjacent recording tracks. Therefore, the main pole can be easily designed.

Incidentally, the discrete track media can be manufactured using the so-called imprint method. Accordingly, the discrete track media can be manufactured without difficulty in spite of a variation in the width b of the guard band depending on the position in the radial direction of the discrete track media as shown in FIG. 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A perpendicular magnetic recording apparatus comprising:
a discrete track media comprising a substrate and a soft magnetic layer and a perpendicular recording layer formed on the substrate, the perpendicular recording layer including guard bands formed of a groove or a nonmagnetic material magnetically separating recording tracks from one another on the surface thereof; and
a magnetic head comprising a main pole, an auxiliary yoke, and a coil,
wherein the main pole is adapted to have a shape on the air bearing surface satisfying a condition that a length of a line segment which is formed by projecting a side of the main pole along a head traveling direction onto a straight line perpendicular to the head traveling direction is smaller than a width of each of the guard bands in the discrete track media even when the main pole is positioned on any recording track of the discrete track media.

2. The apparatus according to claim 1, wherein the main pole has such a shape on the air bearing surface that a length between a trailing edge and a leading edge of the main pole along the head traveling direction is larger than a track width at the trailing edge.

3. The apparatus according to claim 2, wherein the main pole has a shape on the air bearing surface of substantially rectangle.

4. The apparatus according to claim 2, wherein the main pole has a shape on the air bearing surface of a polygon having projections on both sides.

5. The apparatus according to claim 2, wherein the main pole has a shape on the air bearing surface of a polygon having projections and recesses on both sides.

6. The apparatus according to claim 2, wherein the main pole has such a shape on the air bearing surface that curves forming recesses are formed on both sides.

7. The apparatus according to claim 1, wherein the main pole has such a shape on the air bearing surface that a track width at the leading edge is larger than a track width at the trailing edge.

8. The apparatus according to claim 1, wherein the width of the guard band varies depending on a position thereof in a radial direction of the discrete track media.

9. The apparatus according to claim 8, wherein the width of the guard band is larger in inner and outer peripheral portions of the discrete track media and is smaller in an intermediate portion along the radial direction of the discrete track media.
